(19) United States
(12) Patent Application Publication
(10) Pub. No.: US 2022/0225600 A1
(43) Pub. Date: Jul. 21, 2022

(54) Insect Trapping Device And Method Of Use

(71) Applicant: Guadalupe Gonzalez, Visalia, CA (US)

(72) Inventor: Guadalupe Gonzalez, Visalia, CA (US)

(21) Appl. No.: 17/151,807

(22) Filed: Jan. 19, 2021

(51) Int. Cl. A01M 1/16; A01M 1/02; A01M 1/10

(52) U.S. Cl. CPC A01M 1/165; A01M 1/106; A01M 1/02

(57) ABSTRACT

An insect trapping device for trapping insects and shielding them from view includes a housing, which defines an interior space. The housing has a top, which is open. A panel is selectively insertable through the top into the interior space. A fastener engaged to a back of the housing can engage a substrate so that the housing is mounted thereto. An adhesive compound and an attractant are positioned upon a surface of the panel. The attractant attracts insects into the interior space and the adhesive compound traps insects landing upon the panel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to trapping devices and more particularly pertains to a new trapping device for trapping insects and shielding them from view. The present invention discloses a trapping device comprising an open topped housing that is mountable to a wall and which has a panel removably positionable therein. An adhesive compound and an attractant are positioned on the panel. Insects attracted to the panel are trapped thereupon but are not viewable when the housing is mounted above eye level.

### (2) Description of Related Art Including Information Disclosed Under 37 CFR 1.97 and 1.98

The prior art relates to trapping devices. Prior art trapping devices may comprise apparatus having insect attracting lights with flypaper positioned proximately thereto. Prior art trapping devices thus require a power source. What is lacking in the prior art is a trapping device comprising an open topped housing that is mountable to a wall and which has a panel removably positionable therein. An adhesive compound and an attractant are positioned on the panel. Insects attracted to the panel are trapped thereupon but are not viewable when the housing is mounted above eye level.

### BRIEF SUMMARY OF THE INVENTION

An embodiment of the disclosure meets the needs presented above by generally comprising a housing, which defines an interior space. The housing has a top, which is open. A panel is selectively insertable through the top into the interior space. A fastener engaged to a back of the housing is configured to engage a substrate so that the housing is mounted thereto. An adhesive compound and an attractant are positioned upon a surface of the panel. The attractant is configured to attract insects into the interior space and the adhesive compound is configured to trap insects landing upon the panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an insect trapping device according to an embodiment of the disclosure.

FIG. 2 is a front view of an embodiment of the disclosure.

FIG. 3 is a side in-use view of an embodiment of the disclosure.

FIG. 4 is a back view of an embodiment of the disclosure.

FIG. 5 is a top view of an embodiment of the disclosure.

FIG. 6 is a flow diagram for a method of an embodiment of the disclosure.

### DETAILED DESCRIPTION OF THE INVENTION

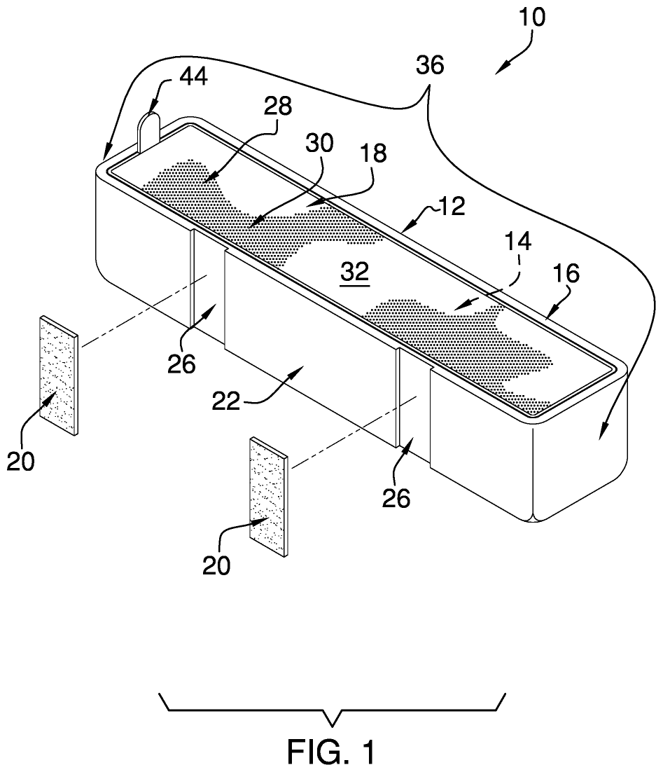

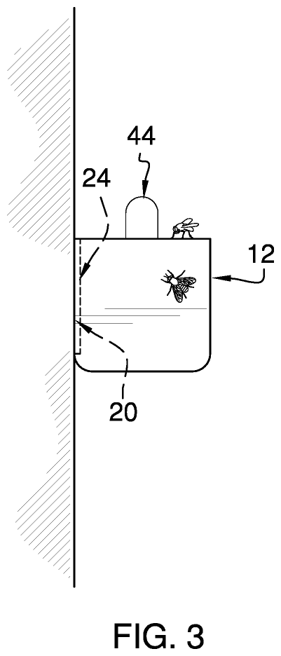

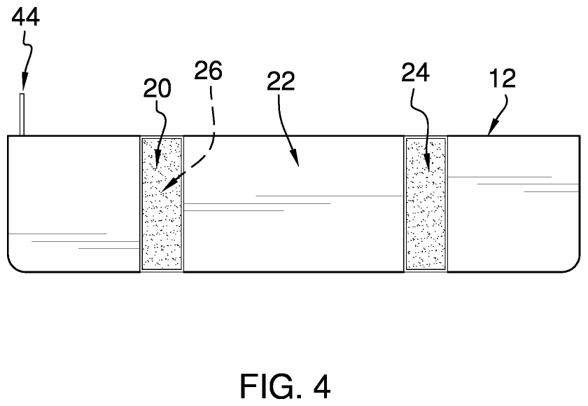

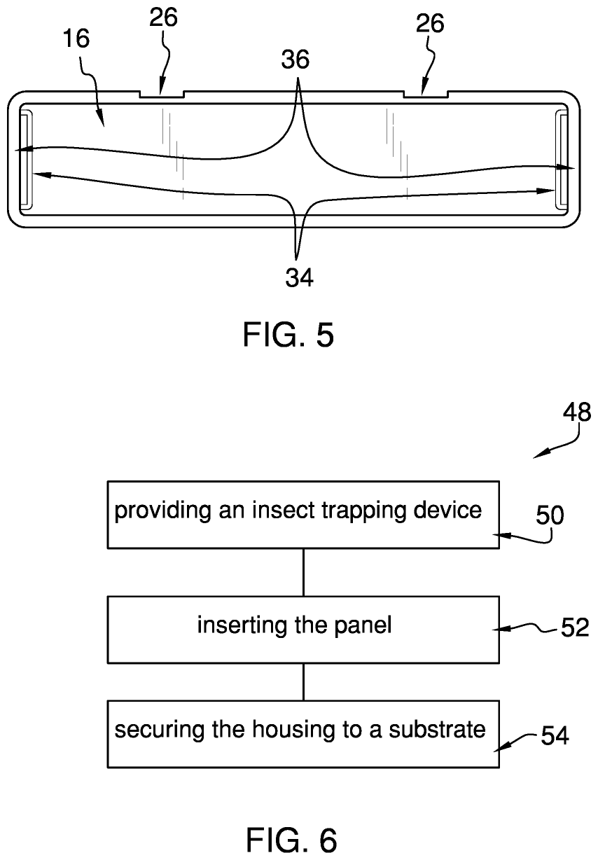

With reference now to the drawings, and in particular to FIGS. 1 through 6 thereof, a new trapping device embodying the principles and concepts of an embodiment of the disclosure and generally designated by the reference numeral 10 will be described.

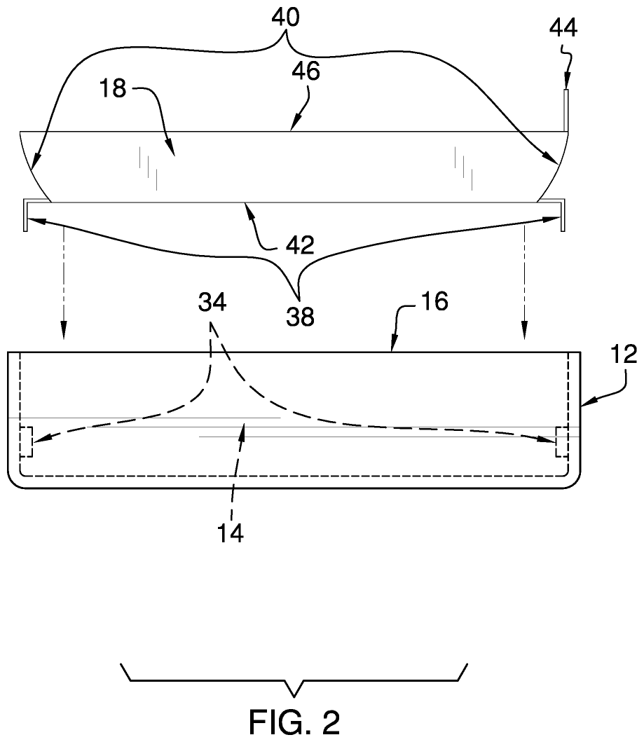

As best illustrated in FIGS. 1 through 6, the insect trapping device 10 generally comprises a housing 12, which defines an interior space 14. The housing 12 may be cuboid shaped, as shown in FIG. 1, or alternately shaped, such as, but not limited to, half cylinder shaped, semihemispherically shaped, and the like. The housing 12 has a top 16, which is open. A panel 18 is selectively insertable through the top 16 into the interior space 14. The panel 18 may be trough shaped, as shown in FIG. 2. The present invention anticipates the panel 18 be alternately shaped, such as, but not limited to, open topped box shaped, planar, and the like.

A fastener 20 engaged to a back 22 of the housing 12 is configured to engage a substrate, such as a wall, column, and the like, so that the housing 12 is mounted thereto. The fastener 20 may comprise an adhesive strip 24, as shown in FIG. 1, or other fastening means, such as, but not limited to, keyhole slots for screwing the housing 12 to the substrate, suction cups, and the like. The back 22 of the housing 12 has a recess 26 extending thereinto, as shown in FIG. 1, wherein two recesses 26 extend into the back 22 of the housing 12. The adhesive strip 24 is positioned in the recess 26 so that the housing 12 is mountable flush to the substrate.

An adhesive compound 28 and an attractant 30 are positioned upon a surface 32 of the panel 18. The present invention also anticipates the panel 18 being impregnated with one or both of the adhesive compound 28 and the attractant 30. The attractant 30 is configured to attract insects into the interior space 14 and the adhesive compound 28 is configured to trap insects landing upon the panel 18. The adhesive compound 28 may comprise rosin, rubber, or combination thereof.

The device 10 also may comprise a pair of rings 34 engaged singly to opposed ends 36 of the housing 12 and extending into the interior space 14. A pair of tabs 38 is engaged singly to and extends from opposing ends 40 of the panel 18, proximate to a lower limit 42 thereof. Each tab 38 is positioned to be inserted into a respective ring 34 as the panel 18 is inserted into the interior space 14 so that the tabs 38 removably engage the panel 18 to the housing 12.

A handle 44 is engaged to and extends from a respective opposing end 40 of the panel 18, proximate to an upper limit 46 thereof. The handle 44 is configured to be grasped in digits of a hand of a user, positioning the user to remove the panel 18 from the interior space 14.

In use, the device 10 is configured to attract and to trap insects, enabling a method 48 of trapping insects. The method 48, as generally shown in FIG. 6, comprises a first step 50 of providing an insect trapping device 10 comprises a housing 12 having a fastener 20 engaged thereto and a panel 18 insertable thereinto. An adhesive compound 28 and an attractant 30 are positioned on the panel 18. In a second step 52 of the method 48, the panel 18 is inserted into the interior space 14. A third step 54 of the method 48 entails securing the housing 12 to a substrate using the fastener 20. The attractant 30 attracts insects into the interior space 14 and the adhesive compound 28 traps insects landing upon the panel 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An insect trapping device comprising:
a housing defining an interior space, the housing having a top, the top being open;
a fastener engaged to a back of the housing and being configured for engaging a substrate, such that the housing is mounted thereto;
a panel selectively insertable through the top into the interior space; and
an adhesive compound and an attractant positioned upon a surface of the panel, wherein the attractant is configured for attracting insects into the interior space and the adhesive compound is configured for trapping insects landing upon the panel.

2. The insect trapping device of claim 1, wherein the housing is cuboid shaped.

3. The insect trapping device of claim 1, wherein the fastener comprises an adhesive strip.

4. The insect trapping device of claim 3, wherein the back of the housing has a recess extending thereinto, the adhesive strip being positioned in the recess, such that the housing is mountable flush to the substrate.

5. The insect trapping device of claim 1, wherein the panel is trough shaped.

6. The insect trapping device of claim 1, wherein the adhesive compound comprises rosin, rubber, or combination thereof.

7. The insect trapping device of claim 1, further including:
a pair of rings engaged singly to opposed ends of the housing and extending into the interior space; and
a pair of tabs engaged singly to and extending from opposing ends of the panel, proximate to a lower limit thereof, such that each tab is positioned for insertion into a respective ring as the panel is inserted into the interior space, such that the tabs removably engage the panel to the housing.

8. The insect trapping device of claim 1, further including a handle engaged to and extending from a respective opposing end of the panel, proximate to an upper limit thereof, wherein the handle is configured for grasping in digits of a hand of a user, positioning the user for removing the panel from the interior space.

9. A method of trapping insects, the method comprising the steps of:
providing an insect trapping device comprising:
a housing defining an interior space, the housing having a top, the top being open,
a fastener engaged to a back of the housing,
a panel selectively insertable through the top into the interior space, and
an adhesive compound and an attractant positioned upon a surface of the panel, wherein the attractant is configured for attracting insects into the interior space and the adhesive compound is configured for trapping insects landing upon the panel;
inserting the panel through the top into the interior space; and
securing the housing to a substrate using the fastener.

10. The method of trapping insects of claim 9, wherein the housing is cuboid shaped.

11. The method of trapping insects of claim 9, wherein the fastener comprises an adhesive strip.

12. The method of trapping insects of claim 11, wherein the back of the housing has a recess extending thereinto, the adhesive strip being positioned in the recess, such that the housing is mountable flush to the substrate.

13. The method of trapping insects of claim 9, wherein the panel is trough shaped.

14. The method of trapping insects of claim 9, wherein the adhesive compound comprises rosin, rubber, or combination thereof.

15. The method of trapping insects of claim 9, further including:
a pair of rings engaged singly to opposed ends of the housing and extending into the interior space; and
a pair of tabs engaged singly to and extending from opposing ends of the panel, proximate to a lower limit thereof, such that each tab is positioned for insertion into a respective ring as the panel is inserted into the interior space, such that the tabs removably engage the panel to the housing.

16. The method of trapping insects of claim 9, further including a handle engaged to and extending from a respective opposing end of the panel, proximate to an upper limit thereof, wherein the handle is configured for grasping in digits of a hand of a user, positioning the user for removing the panel from the interior space.

17. An insect trapping device comprising:
a housing defining an interior space, the housing having a top, the top being open, the housing being cuboid shaped;
a fastener engaged to a back of the housing and being configured for engaging a substrate, such that the housing is mounted thereto, the fastener comprising an adhesive strip, the back of the housing having a recess extending thereinto, the adhesive strip being positioned in the recess, such that the housing is mountable flush to the substrate;
a panel selectively insertable through the top into the interior space, the panel being trough shaped;
an adhesive compound and an attractant positioned upon a surface of the panel, wherein the attractant is configured for attracting insects into the interior space and the adhesive compound is configured for trapping insects landing upon the panel, the adhesive compound comprising rosin, rubber, or combination thereof;
a pair of rings engaged singly to opposed ends of the housing and extending into the interior space;
a pair of tabs engaged singly to and extending from opposing ends of the panel, proximate to a lower limit thereof, such that each tab is positioned for insertion into a respective ring as the panel is inserted into the interior space, such that the tabs removably engage the panel to the housing; and
a handle engaged to and extending from a respective opposing end of the panel, proximate to an upper limit thereof, wherein the handle is configured for grasping in digits of a hand of a user, positioning the user for removing the panel from the interior space.
